(19) United States
(12) Patent Application Publication
(10) Pub. No.: US 2006/0288212 A1
(43) Pub. Date: Dec. 21, 2006

(54) Transparent user and session management for web applications

(75) Inventor: Hiang-Swee Chiang, Elmhurst, NY (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Gutenberg Printing LLC, Los Altos, CA (US)

(21) Appl. No.: 11/510,055

(22) Filed: Aug. 25, 2006

Related U.S. Application Data
(63) Continuation of application No. 09/812,634, filed on Mar. 20, 2001.

(51) Int. Cl. H04L 9/00

(52) U.S. Cl. 713/170

(57) ABSTRACT

A central server used to generate, for example, web application instances to remote users over a computer network, such as the Internet, is implemented with new programming techniques by which user and session management is made independent of the web application instance. The prior methods, by which a new user or session cookie is generated for each user request, is replaced by techniques wherein a single session cookie is provided to a user for all requests in a single user session. A user database is maintained by the central server which stores the session cookie and correlates it to a web application instance, identified by system variables stored in the database, rather than with application variables maintained by an application instance.

### CROSS-REFERENCE TO RELATED APPLICATIONS

This application is a continuation of U.S. application Ser. No. 09/812,634, filed Mar. 20, 2001, now pending, which claims benefit to U.S. Provisional Application No. 60/190,389, filed Mar. 20, 2000, the entirety of which is hereby incorporated by reference.

### AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This application relates generally to process coordinating for multiple electrical computers, and relates more particularly to establishing computer-to-computer sessions.

### BACKGROUND OF THE INVENTION

The stateless nature of Hyper-Text Transfer Protocol (HTTP) is a disadvantage of any web application that runs on a server computer connected to a network and which uses HTTP to communicate with client web browsers. This is because the HTTP protocol is generally a stateless request/response protocol. That is, for every request generated by a user, the web application provides a response which typically includes one or more variables used by the application to identify the user and/or the session. In order to accomplish user an/or session management, these variables are returned with a subsequent request by the user. Without that, the HTTP protocol does not inform the server whether a series of consecutive requests are coming from the same web browser and/or user or different web browsers and/or users.

Session management, as used herein, refers to one or more algorithms used for identifying consecutive requests made by a particular web browser. User management, as used herein, refers to one or more algorithms used for identifying consecutive requests made by different web browsers but from the same user.

For any web application which uses HTTP protocol to communicate with a web browser, it is very important to ascertain whether consecutive requests come from the same web browser and/or user. To enable session as well as user management, prior web applications were designed to send one or more cookies as part of an initial response to a web browser. In turn, a web browser was required to return one or more cookies as part of the subsequent request.

The following is an example of existing techniques used in managing users and sessions via cookies in a network environment. A client terminal sends a request to the server in the form of a request method, a uniform resource identifier (URI), and a protocol version, followed by a Multipurpose Internet Mail Extensions (MIME)-like message containing request modifiers, client information, and possibly, body content. The server responds with a status line, including the message's protocol version and a success or error code, followed by a MIME-like message containing server information, entity meta-information, and possibly, entity-body content.

Existing web applications managed by servers are designed to internally manage cookies from incoming requests to identify different sessions and/or users in this manner. However, developing the software code for managing the cookies associated with the HTTP protocol is time consuming and error prone.

Alternatively, both software libraries and session objects have also been used to enable web applications to manage different users and/or sessions. The first approach provides two variables to a web application for each request to identify the session and user. The web application can then use either hash tables in memory, files on a file system or tables in a database system to keep the application states associated with each session and user.

The second approach provides a session object to a web application for each request. The session object allows the web application to store the application states associated with the session in the object.

Software libraries and session objects, however, are also difficult to incorporate into an object-oriented software development framework. Hash tables and session objects are simply data structures used to store application states without the corresponding methods for manipulating the underlying data. They also cannot enforce type-checking for the data that they store.

### SUMMARY OF THE INVENTION

The systems and methods of the present invention address certain shortcomings in existing technologies.

In one embodiment of the present invention, a method for providing user and session management, and associated systems for implementing the same, includes a central server receiving a first request from a user for an application instance, the request includes a single identifier for all requests from the user without further user and session application variables. The application response is then transmitted to the user.

In a second embodiment of the present invention, a method for providing user and session management, and associated systems for implementing the same, includes a central server receiving a request for an application instance from a user. A single identifier is assigned to the user for handling all the user's requests. The central server then transmits the application instance response to the user, wherein the single identifier is static for all requests from the user for a single session.

In a third embodiment of the present invention, a method for providing user and session management, and associated systems for implementing the same, includes a central server receiving a first request from a user for a first application instance. The first request includes an identifier corresponding to the first user. The central server transmits the first application instance response to the user. The central server then receives a second request from the user for a second application instance. The second request includes only the same identifier. The central server then processes the request with the first application instance.

In a fourth embodiment of the present invention, a method for providing user and session management, and associated systems for implementing the same, includes a central server receiving a first user request in a first user session, the first user request including a first identifier. The central server transmits a first application instance response to the first user in response to the first request. The central server the receives, from the first user, a second user request in a second user session, the second user request including the first identifier. The central server then processes the second request through the first application instance.

In a fifth embodiment of the present invention, a method for providing user and session management, and associated systems for implementing the same, includes a central server receiving a first request from a first user session for a user, the first request including an identifier. The central server then receives a second request from a second user session for the user, the second request including the identifier without further user or session variables. The central server then transmitting a response to the first and second requests, based on the identifier and a session information stored for each of the first and second user sessions.

In a sixth embodiment of the present invention, a method for providing user and session management, and associated systems for implementing the same, includes a central server receiving a first request from a first user session for a user, the first request including an identifier. The central server transmits a response to the first request, based on the identifier and a first session variable stored in a user database. The central server then receives a second request from a second user session for the user, the second request including the identifier without further user or session variables. The central server then transmits a response to the second request, based on the identifier and second session information stored in the user database.

In a seventh embodiment of the present invention, a method for providing user and session management, and associated systems for implementing the same, includes a central server receiving a first request from a first user, the first request including a first identifier corresponding to the first user. The central server receives a second request from a second user, the second request including a second identifier corresponding to the second user. The central server then generates a first application instance responsive to the first identifier and a second application instance responsive to the second identifier.

In an eighth embodiment of the present invention, a method for providing user and session management, and associated systems for implementing the same, includes a central server receiving, from a first user, a first request in a first session, the first request including a first identifier. The central server then transmits a first application instance to the first user in response to the first request. The central server then receives, from the first user, a second request in a second session, the second request including the first identifier. The central server processes the second request through the first application instance. The central server then receives a third request in a third session from a second user, the third request including a second identifier. The central server then transmits a second application instance to the second user in response to the third request.

In a ninth embodiment of the present invention, a method for providing user and session management, and associated systems for implementing the same, includes a client terminal interacting with a central server over a computer network. The client terminal transmits a first request to a central server, the first request including a user identifier. The client terminal receives a first application instance in response to the first request from the central server and transmits a second request to the central server, the second request including the identifier without further user or session variables. The client terminal then receives a response to the second request through the same application instance.

In a tenth embodiment of the present invention, a method for providing user and session management, and associated systems for implementing the same, includes a client terminal interacting with a central server over a computer network. The client terminal transmits a first request to the central server in a first user session, the first request including a user identifier. The client terminal then receives a first application instance in response to the first request. The client terminal next transmits a second request to the central server in a second user session, the second request including the identifier without further user or session variables. The client terminal then receives a response to the second request from the same application instance.

It is therefore one advantage of certain embodiments of the present invention that a centralized user database that can be maintained for storing and accessing user and state information for web applications to accomplish user and/or session management.

It is a further advantage of certain embodiments of the present invention that the need to write user and session management codes for a web application are eliminated. This, in turn reduces the potential for application bugs and, therefore, the amount of time and money needed to write a web applications.

Another advantage of certain embodiments of the present invention is that a full object-oriented software development can be used in web application development without using type-less session objects or hash tables.

### BRIEF DESCRIPTION OF THE DRAWINGS

The features and advantages of the present invention will now be described in conjunction with the attached drawings, of which:

FIG. 1 is a block diagram depicting an exemplary computer network through which the present invention may be accomplished;

FIG. 2 is a schematic block diagram of an exemplary central server for use with the network of FIG. 1;

FIG. 3 is an illustration of an exemplary user/session database maintained by the central server of FIG. 2;

FIG. 4 is a flow chart illustrating an exemplary process for user/session management performed by the central server of FIG. 2;

FIG. 5 is a flow chart illustrating an exemplary user session performed by the user client terminal of FIG. 1;

FIGS. 6A, 6B, 6C, 6D, and 6E are an exemplary program listing of a program employing user and session management code of existing technologies; and

FIGS. 7A and 7B are an exemplary program listing utilized by the central server of FIG. 2 which accommodates the user and session management techniques according to the present invention.

### DETAILED DESCRIPTION OF ILLUSTRATIVE EMBODIMENTS

As used herein, the term “session” refers to an interaction between a user and a server which begins with a log-in request by the user and concludes with either a log-out request by the user or a session time-out generated by the server after a predetermined time.

The present invention achieves the above-mentioned advantages by creating multiple instances of a web application for multiple users in contrast to the traditional approach of creating a single instance of a web application for multiple users or creating a single instance of a web application for each individual web browser request. Furthermore, the present invention provides a server that generates and stores system variables relating to a user and a session to generate and track us of an application instance independent of the application, rather than having the application generate and track application variables which as is done in existing technologies. Furthermore, for each request from a user interacting simultaneously with multiple sessions, it is possible to maintain each application instance involved in the user's sessions rather than deleting a prior instance upon the receipt of each new request from the user.

The transparent user and session management of the present invention introduces a system architecture and runtime environment that allows web applications to adopt a fully object-oriented approach. The runtime environment, according to certain embodiments of the present invention, removes the difficulties in programming web applications to accomplish session and user management in that the web application developers no longer need to be concerned with developing the code (and debugging the same) to manage cookies with HTTP protocol and/or using hash tables or session objects to store application states.

The features of the inventive runtime environment in various embodiments include: (1) transparently mapping requests from the same session to the same instances of a web application; (2) transparently mapping requests from different sessions of the same user to the same instances of a web application; and (3) transparently mapping requests from different users to different instances of a web application.

Accordingly, those of ordinary skill in the art will readily appreciate that the techniques of the present invention allow web applications to be developed as single-user applications with the runtime environment transparently deploying them as multiuser web applications. From a programmer's perspective, developing a multi-user web application is exactly the same as developing a single-user web application. The programmer develops an object that can accept incoming requests, process the requests, store the application states in the object instance variables and return the corresponding responses. In an embodiment of the invention where the Java programming language is used, for example, the object may be a Java servlet object. The programmer need not worry about cookies in the requests, which session the requests originate from and which user the requests originate from. This dramatically reduces the number of lines of code, the number of potential bugs, the development time and lets the programmer concentrate on the business logic used to process the requests.

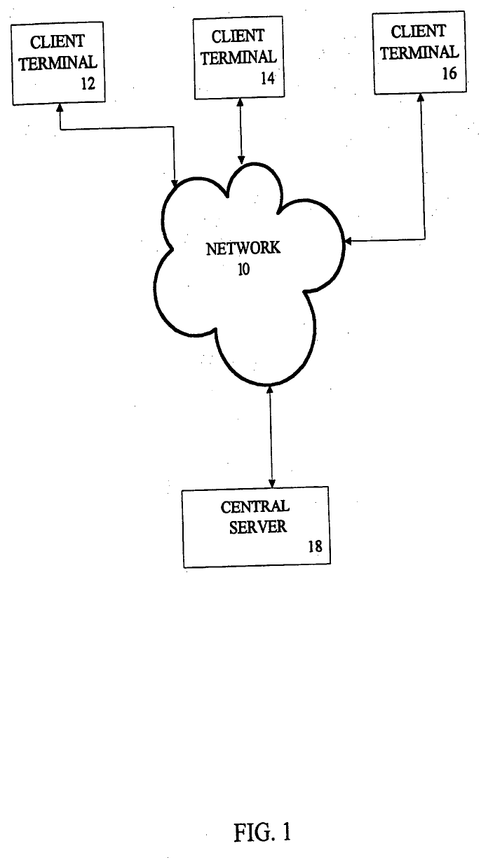

Referring now to FIG. 1, there is depicted an exemplary computer network 10 through which a plurality of remote client terminals 12, 14, 16 may communicate with a central server 18 in any known manner. Although computer network 10 is preferably an Internet-based network such as the World Wide Web, it may be any one or more of a local area network (LAN), a wide-area network (WAN), an intranet environment, an extranet environment, a wireless network or any other type of computer network, such as those enabled over public switched telephone networks. In the case of a wireless network, it will be appreciated that although the techniques of the present invention have been described in relation to HTTP protocol, the same techniques may be employed to communicate with a wireless device employing a wireless access protocol (WAP).

Client terminals 12, 14, 16 may each be any type of computing device, such as a personal computer, a workstation, a network terminal, a hand-held remote access device, a personal digital assistant (PDA) or any other device that can accomplish two-way electronic communication over the network 10. Specific functions and operations of client terminals 12-16 and the central server 18 are discussed further below.

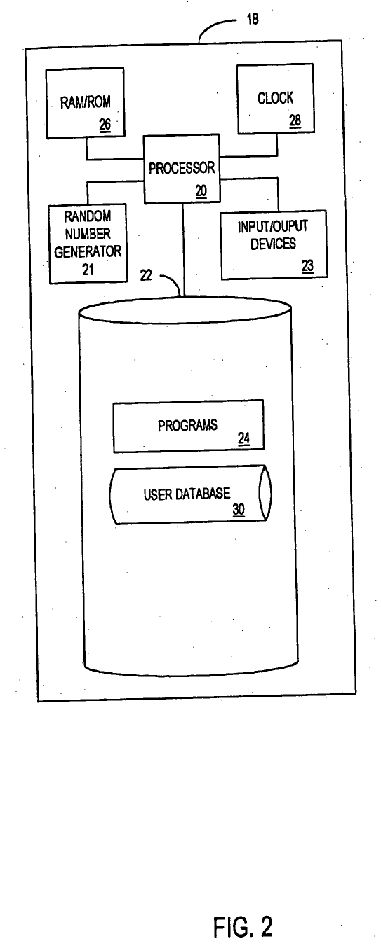

Turning now to FIG. 2, displayed therein are exemplary components of a computing device, such as the central server 18. It should be understood that any of the client terminals 12-16 may share similar configurations. However, for sake of brevity, the discussion immediately below will refer to the central server 18 only. Furthermore, it will be readily appreciated that the central server 18 may be implemented by a plurality of distributed servers acting in conjunction with each other, rather than as a single device as displayed in FIG. 2.

The primary component of the server 18 is a processor 20, which may be any commonly available microprocessor, such as the PENTIUM 4 manufactured by INTEL CORP. The processor 20 may be operatively connected to further exemplary components, such as RAM/ROM 26, a clock 28, input/output devices 23, a random number generator 21 and a memory 22 which, in turn, stores one or more computer programs 24.

The processor 20 operates in conjunction with random access memory and read-only memory in a manner well known in the art. The random-access memory (RAM) portion of RAM/ROM 26 may be a suitable number of Single In-line Memory Module (SIMM) chips having a storage capacity (typically measured in kilobytes or megabytes) sufficient to store and transfer, inter alia, processing instructions utilized by the processor 20 which may be received from the programs 24. The read-only memory (ROM) portion of RAM/ROM 26 may be any permanent non-rewritable memory medium capable of storing and transferring, inter alia, processing instructions performed by the processor 20 during a start-up routine of the central server 18.

The clock 28 may be an on-board component of the processor 20 which dictates a clock speed (typically measured in MHz) at which the processor 20 performs and synchronizes, inter alia, communication between the internal components of the central server 18.

The input/output device(s) 23 may be one or more commonly known devices used for receiving operator inputs, network data, and the like and transmitting outputs resulting therefrom. Accordingly, exemplary input devices may include a keyboard, a mouse, a voice recognition unit and the like for receiving operator inputs. Output devices may include any commonly known devices used to present data to an operator of the central server 18 or to transmit data over the computer network 10 to a remote user or customer. Accordingly, suitable output devices may include a display, a printer and a voice synthesizer connected to a speaker.

Other input/output devices 23 may include a telephonic or network connection device, such as a telephone modem, a cable modem, a T-1 connection, a digital subscriber line or a network card, for communicating data to and from other computer devices over the computer network 10, such as to remote client terminals 12-16. In an embodiment involving a Web server, it is preferred that the communications devices used as input/output devices 23 have capacity to handle high bandwidth traffic in order to accommodate communications with a large number of remote client terminals 12-16.

The memory 22 may be an internal or external large capacity device for storing computer processing instructions, computer-readable data, and the like. The storage capacity of the memory 22 is typically measured in megabytes or gigabytes. Accordingly, the memory 22 may be one or more of the following: a floppy disk in conjunction with a floppy disk drive, a hard disk drive, a CD-ROM disk and reader/writer, a DVD disk and reader/writer, a ZIP disk and a ZIP drive of the type manufactured by IOMEGA CORP., and/or any other computer readable medium that may be encoded with processing instructions in a read-only or read-write format. Further functions of and available devices for memory 22 will be apparent.

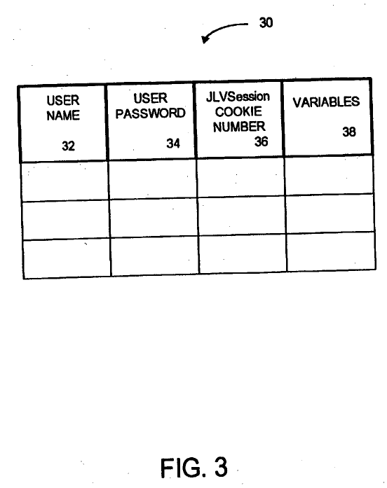

The memory 22 preferably stores, inter alia, a plurality of programs 24 which may be any one or more of an operating system such as WINDOWS 2000 by MICROSOFT CORP. The plurality of programs 24 may also include a database management program for maintaining and interacting with the user database 30 of FIG. 3. The plurality of programs 24 may further contain one or more application programs, such as a web hosting program, which may be necessary to implement the embodiments of the present invention. The programs 24 include processing instructions for enabling the processor 20 to perform the user and session management techniques described herein.

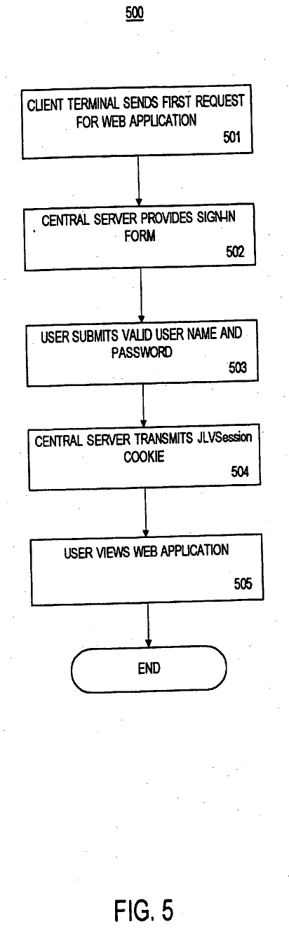

Referring now to FIG. 3, an exemplary user database 30 is provided to store and maintain user and session management data according to the present invention. The data is received and stored according to the process 500 as described below with respect to FIG. 5. In referring to the database 30 depicted herein, it is important to note that the first row of the database 30 include a field header for each field 32-38 of the database 30 and the remaining rows each correspond to one record of the database. Fields of data, are represented by each column. Further or fewer fields and records of data may be used. The databases presented herein may be configured into any number of relational databases. In addition, configurations other than database formats may be used to store the data maintained in the exemplary databases.

Accordingly, the user database 30 may include a user name field 32 for storing a user name parameter corresponding to a user submitting a request via one of the client terminals 12-16. The user database 30 may further contain: a user password field 34 for storing a password parameter corresponding to the user name in field 32; a JLVSession cookie number field 36 for storing a randomly-generated number or identifier assigned to the user and transmitted with user requests within the JLVSession cookie; and a variables field 38 for storing the user and session management system information corresponding to the web application instance accessed by the user.

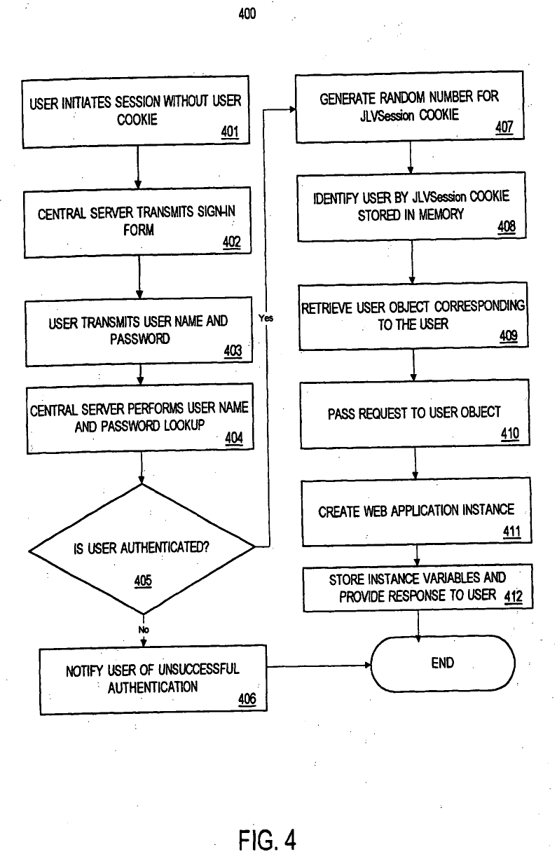

Referring now to FIG. 4, therein is illustrated an exemplary process 400 performed by the central server for accomplishing user and session management according to certain embodiments of the present invention. The process 400 begins when a client terminal initiates a web browser session that sends a request without any user-session cookie to the runtime environment (step 401). The runtime environment maintained by the central server then returns a system defined customizable web page with a sign-in form to the web browser (step 402). The sign-in form may include fields for submitting a first parameter for a usemame corresponding to the user (also referred to herein as JLVUsername), a second parameter for a password corresponding to the user (also referred to herein as JLVPassword ) and a third parameter (also referred to herein as JLMClick) which contains the default exemplary value “JLSSignln” for allowing the runtime environment to recognize that the user-submitted values for these parameters are in conjunction with a sign-in request. It should be noted that the first and the second parameter may correspond to values stores in fields 32 and 34 of user database 30. It will also be readily appreciated that any default value may be used for the JLMClick parameter.

After the user fills in the username and password and submits the form to the central server 18 (step 403), the runtime environment authenticates the user relative to the appropriate fields of the user database 30 (step 404). Next, at step 405, if authentication is successful, the runtime environment returns a redirection response to the original request URL together with a single cookie (also referred to herein as the JLVSession cookie, which may contain a static, unchanging value) that includes a random number generated by the central server 18 via random number generator 21 for uniquely identifying the user and the session (step 407), after which the process 400 continues as described further below. If, however, at step 405 the authentication is unsuccessful (i.e. no corresponding user name and password is found), the runtime environment notifies the user that the session is inaccessible (step 406), after which the process 400 ends. Alternatively, in environments which allow for such, the user name and password may be added to the user database 30 as a new record, thereby identifying the user as a new user and allowing the user to access the web application.

Returning to step 407, for each request with a JLVSession cookie after successful sign-in, the runtime environment uses the JLVSession cookie value from field 36 to identify the user from whom the request originated (step 408), retrieves the instance of a user object corresponding to that particular user (step 409), and finally passes the request to the user object (step 410). The user object in turn uses the URL within the request to identify the web application that is targeted. If an instance of the web application has not been created, the user object will create a new instance of the web application (step 411). After that, the user object simply passes the request to the web application instance. The web application instance processes the request, stores any application states in its instance variables and then returns a response (step 412), after which the process 400 ends. Alternatively, the process 400 may return to step 408 above if further requests with the JLVSession cookie are submitted.

FIG. 5 is an illustration of a process 500, performed by any number of client terminals 12-16, for submitting requests and interacting with the central server employing the techniques of the present invention. For example, a client terminal 12 sends a first request for a web application to the central server 18 (step 501). The central server 18 returns a sign-in form for completion by the user operating client terminal 12 (step 502). The user then submits a valid user name and password (step 503) and receives a JLVSession cookie (generated as described above) to be submitted with each subsequent request (step 504). The user then receives a response from the instance of the web application (step 505), after which process 500 ends. Alternatively, the process 500 may return to step 504 above for each subsequent request submitted by the user for receiving subsequent web application instance responses.

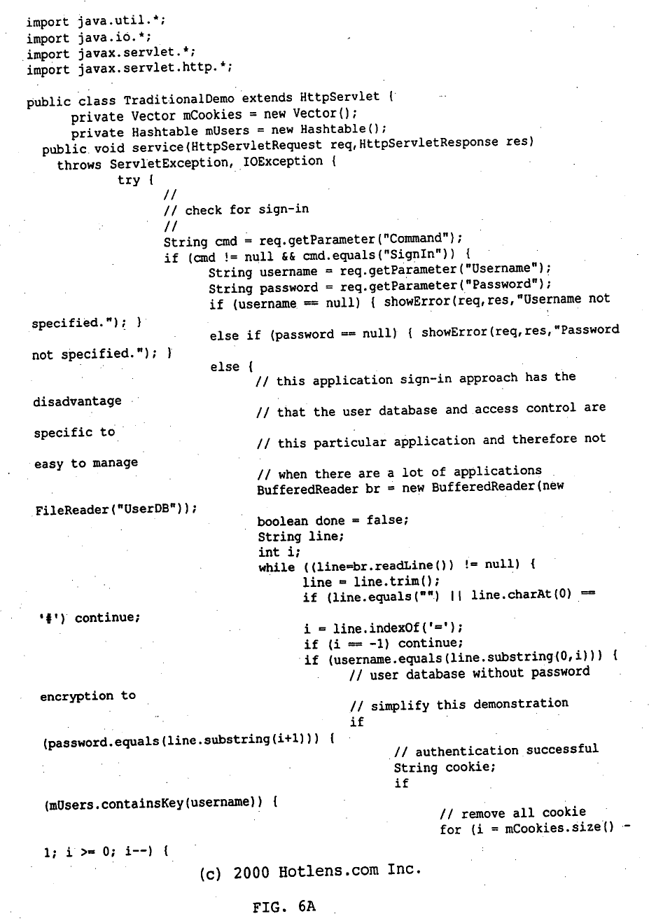

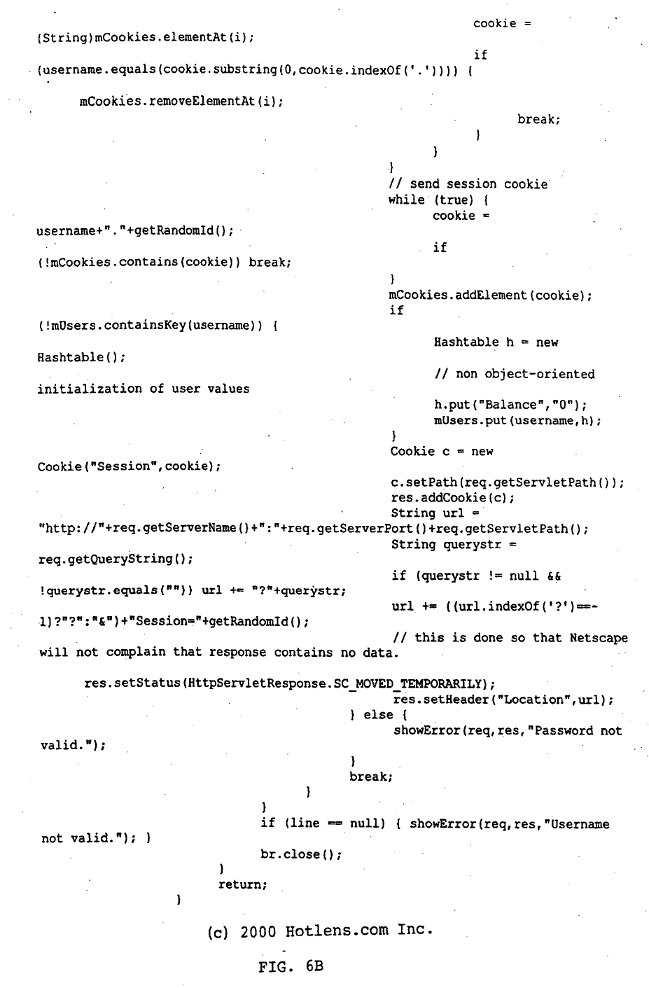

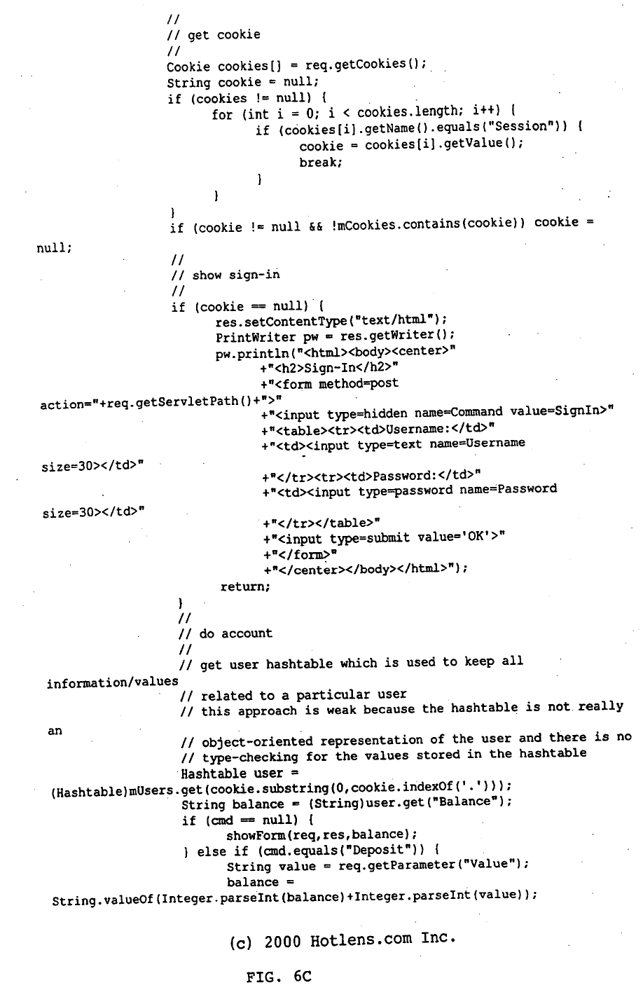

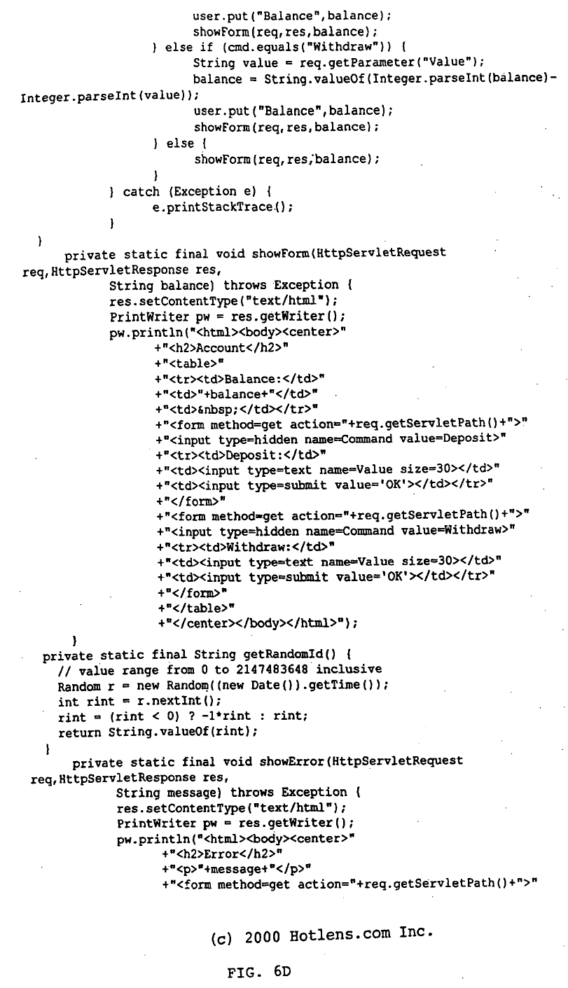

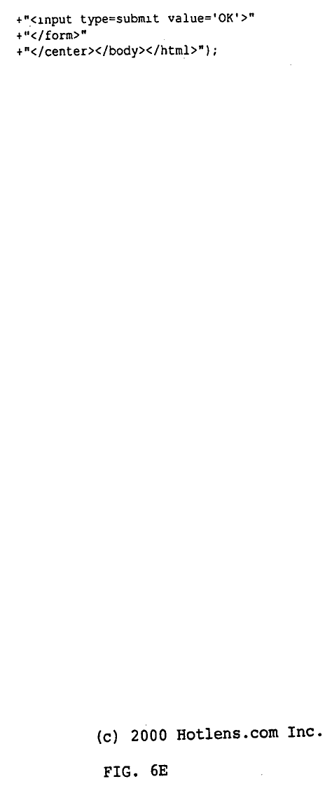

FIGS. 6A-6E contain a program listing 600 for implementing a web application according to existing programming techniques, which listing includes user and session management code.

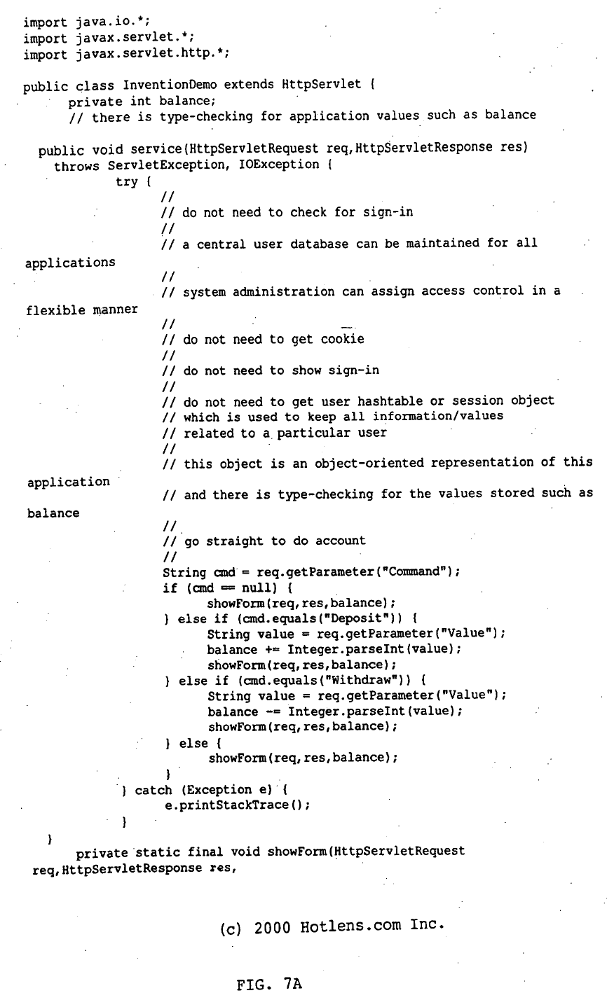

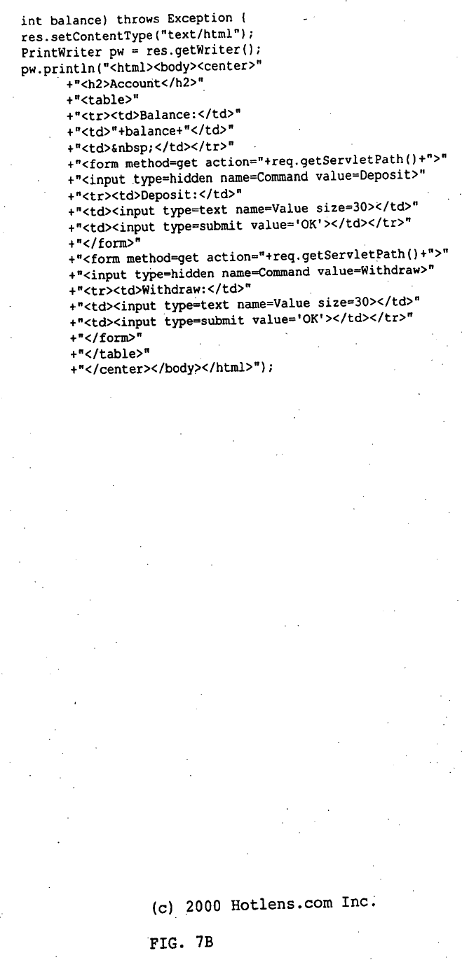

FIGS. 7A-7B are an exemplary program listing 700 for accomplishing the same function as the listing in FIGS. 7A-7E, using the techniques of the present invention. The difference in the size of the two program listings illustrates the ability of the present invention to dramatically reduce the code needed to develop a web application through elimination of user and session management code.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed:

1. A method for providing session management with respect to client-server interactions over a computer network, comprising:
providing a server runtime environment;
maintaining a database for storing and accessing user and state information for web applications; and
employing said server runtime environment and database to map client requests to instances of a web application that relies on said server and database to provide user and session management functionality.

2. A method as recited in claim 1, wherein requests from a session are mapped to matching instances of the web application.

3. A method as recited in claim 2, wherein the mapping of requests from a session to matching instances of the web application comprises transparently mapping said requests.

4. A method as recited in claim 1, wherein requests from different sessions of a client are mapped to matching instances of the web application.

5. A method as recited in claim 4, wherein the mapping of requests from different sessions of a client to matching instances of the web application comprises transparently mapping said requests.

6. A method as recited in claim 1, wherein requests from different clients are mapped to different instances of the web application.

7. A method as recited in claim 6, wherein the mapping of requests from different clients to different instances of the web application comprises transparently mapping said requests.

8. A method as recited in claim 1, further comprising managing a first session comprising an interaction over the network between a client and a server, said interaction begining with a log-in request by the client and concluding with one of a log-out request by the client and a session time-out generated by the server.

9. A method as recited in claim 1, wherein said database comprises a record including information indicative of a user name, a user password corresponding to the user name, a number assigned to the user, and user and session management information corresponding to a web application instance.

10. A method as recited in claim 9, wherein the number comprises a randomly-generated number assigned to the user and transmitted with client requests.

11. A method as recited in claim 10, wherein the randomly-generated number is stored in a JLVSession cookie.

12. A method as recited in claim 1, further comprising receiving from a client a request without any client-session cookie, and returning to the client a web page with a sign-in form, the sign-in form including fields for submitting a first parameter for a usemame corresponding to the user, a second parameter for a password corresponding to the user, and a third parameter enabling the runtime environment to recognize that the user-submitted values for these parameters are in conjunction with a sign-in request.

13. A method as recited in claim 12, further comprising receiving the sign-in form back from the client, authenticating the user with reference to information in the database, and returning to the client a redirection response together with a cookie that includes a random number generated by the server, wherein the random number uniquely identifies the user and the session.

14. A method as recited in claim 13, further comprising receiving a subsequent request from the client, employing the database to identify the user from whom the request originated, retrieving a user object corresponding to the user, and passing the subsequent request to the user object.

15. A method as recited in claim 14, wherein the user object uses a URL within the request to identify a web application that is targeted, and creating an instance of the web application.

16. A method as recited in claim 1, wherein said web application lacks user and session management functionality and relies on said server and database to provide this functionality.

17. A method as recited in claim 16, wherein said session management functionality includes an algorithm for identifying consecutive requests made by a particular web browser.

18. A method as recited in claim 16, wherein said user management functionality includes an algorithm for identifying consecutive requests made by different web browsers but from the same user.

19. A computer readable medium comprising instructions for providing session management with respect to client-server interactions over a computer network, said instructions configured to cause a server computer to perform the following steps:
providing a server runtime environment;
maintaining a database for storing and accessing user and state information for web applications; and
employing said server runtime environment and database to map client requests to instances of a web application.

20. A computer readable medium as recited in claim 19, further comprising instructions for mapping requests from a session to matching instances of the web application.

21. A computer readable medium as recited in claim 20, wherein the mapping of requests from a session to matching instances of the web application comprises transparently mapping said requests.

22. A computer readable medium as recited in claim 19, further comprising instructions for mapping requests from different sessions of a client to matching instances of the web application.

23. A computer readable medium as recited in claim 19, wherein the mapping of requests from different sessions of a client to matching instances of the web application comprises transparently mapping said requests.

24. A computer readable medium as recited in claim 19, further comprising instructions for mapping requests from different clients to different instances of the web application.

25. A computer readable medium as recited in claim 24, wherein the mapping of requests from different clients to different instances of the web application comprises transparently mapping said requests.

26. A computer readable medium as recited in claim 19, further comprising instructions for managing a first session comprising an interaction over the network between a client and a server, said interaction begining with a log-in request by the client and concluding with one of a log-out request by the client and a session time-out generated by the server.

27. A computer readable medium as recited in claim 19, wherein said database comprises a record including information indicative of a user name, a user password corresponding to the user name, a number assigned to the user, and user and session management information corresponding to a web application instance.

28. A computer readable medium as recited in claim 27, wherein the number comprises a randomly-generated number assigned to the user and transmitted with client requests.

29. A computer readable medium as recited in claim 28, wherein the randomly-generated number is stored in a JLVSession cookie.

30. A computer readable medium as recited in claim 19, further comprising instructions for: receiving from a client a request without any client-session cookie, and returning to the client a web page with a sign-in form, the sign-in form including fields for submitting a first parameter for a usemame corresponding to the user, a second parameter for a password corresponding to the user, and a third parameter enabling the runtime environment to recognize that the user-submitted values for these parameters are in conjunction with a sign-in request.

31. A computer readable medium as recited in claim 30, further comprising instructions for: receiving the sign-in form back from the client, authenticating the user with reference to information in the database, and returning to the client a redirection response together with a cookie that includes a random number generated by the server, wherein the random number uniquely identifies the user and the session.

32. A computer readable medium as recited in claim 31, further comprising instructions for: receiving a subsequent request from the client, employing the database to identify the user from whom the request originated, retrieving a user object corresponding to the user, and passing the subsequent request to the user object.

33. A computer readable medium as recited in claim 32, wherein the user object uses a URL within the request to identify a web application that is targeted, and creating an instance of the web application.

34. A computer readable medium as recited in claim 19, wherein said web application lacks user and session management functionality and relies on said server and database to provide this functionality.

35. A computer readable medium as recited in claim 34, wherein said session management functionality includes an algorithm for identifying consecutive requests made by a particular web browser.

36. A computer readable medium as recited in claim 34, wherein said user management functionality includes an algorithm for identifying consecutive requests made by different web browsers but from the same user.

37. A system comprising a server, a database, and a computer readable medium, wherein said computer readable medium comprises instructions for carrying out a method for providing session management with respect to client-server interactions over a computer network, said method comprising providing a server runtime environment, maintaining in said database user and state information for web applications, and employing said server runtime environment and database to map client requests to instances of a web application.

38. A system as recited in claim 37, wherein requests from a session are mapped to matching instances of the web application.

39. A system as recited in claim 38, wherein the mapping of requests from a session to matching instances of the web application comprises transparently mapping said requests.

40. A system as recited in claim 37, wherein requests from different sessions of a client are mapped to matching instances of the web application.

41. A system as recited in claim 40, wherein the mapping of requests from different sessions of a client to matching instances of the web application comprises transparently mapping said requests.

42. A system as recited in claim 37, wherein requests from different clients are mapped to different instances of the web application.

43. A system as recited in claim 42, wherein the mapping of requests from different clients to different instances of the web application comprises transparently mapping said requests.

44. A system as recited in claim 37, further comprising managing a first session comprising an interaction over the network between a client and a server, said interaction begining with a log-in request by the client and concluding with one of a log-out request by the client and a session time-out generated by the server.

45. A system as recited in claim 37, wherein said database comprises a record including information indicative of a user name, a user password corresponding to the user name, a number assigned to the user, and user and session management information corresponding to a web application instance.

46. A system as recited in claim 45, wherein the number comprises a randomly-generated number assigned to the user and transmitted with client requests.

47. A system as recited in claim 46, wherein the randomly-generated number is stored in a JLVSession cookie.

48. A system as recited in claim 37, further comprising receiving from a client a request without any client-session cookie, and returning to the client a web page with a sign-in form, the sign-in form including fields for submitting a first parameter for a usemame corresponding to the user, a second parameter for a password corresponding to the user, and a third parameter enabling the runtime environment to recognize that the user-submitted values for these parameters are in conjunction with a sign-in request.

49. A system as recited in claim 48, further comprising receiving the sign-in form back from the client, authenticating the user with reference to information in the database, and returning to the client a redirection response together with a cookie that includes a random number generated by the server, wherein the random number uniquely identifies the user and the session.

50. A system as recited in claim 49, further comprising receiving a subsequent request from the client, employing the database to identify the user from whom the request originated, retrieving a user object corresponding to the user, and passing the subsequent request to the user object.

51. A system as recited in claim 50, wherein the user object uses a URL within the request to identify a web application that is targeted, and creating an instance of the web application.

52. A system as recited in claim 37, wherein said web application lacks user and session management functionality and relies on said server and database to provide this functionality.

53. A system as recited in claim 52, wherein said session management functionality includes an algorithm for identifying consecutive requests made by a particular web browser.

54. A system as recited in claim 52, wherein said user management functionality includes an algorithm for identifying consecutive requests made by different web browsers but from the same user.

55. A system comprising a server, a database, and means for providing session management with respect to client-server interactions over a computer network, said means comprising means for providing a server runtime environment, means for maintaining in said database user and state information for web applications, and means for employing said server runtime environment and database to map client requests to instances of a web application.
